(19) United States
(12) Patent Application Publication
(10) Pub. No.: US 2015/0024089 A1
(43) Pub. Date: Jan. 22, 2015

(54) Natural nutritional supplements

(71) Applicants: Leroy P. Kemp, Palatine, IL (US); Woo Chun Paik, Inverness, IL (US); Mia Scheid, Inverness, IL (US)

(72) Inventors: Leroy P. Kemp, Palatine, IL (US); Woo Chun Paik, Inverness, IL (US); Mia Scheid, Inverness, IL (US)

(73) Assignee: FORZA Technologies LLC, Palatine, IL (US)

(21) Appl. No.: 14/507,054

(22) Filed: Oct. 6, 2014

Related U.S. Application Data
(63) Continuation-in-part of application No. 13/451,329, filed on Apr. 19, 2012.

(51) Int. Cl. A23L 1/29; A23L 1/305; A23L 1/302

(52) U.S. Cl. CPC A23L 1/296; A23L 1/302; A23L 1/3051; A23V 2002/00
USPC 426/72

(57) ABSTRACT

Dietary nutritional supplements specially formulated for use by high school, college and professional athletes, especially wrestlers. The nutritional supplements build strength, endurance and stamina, replenish electrolytes lost during intense sweating, provide essential nutrients, and increase and sustain energy. The nutritional supplements can be mixed with each other in various combinations to provide athletes with essential nutrients as necessary based on the activity undertaken. While designed primarily for athletes with demanding workout routines, the nutritional supplements can benefit persons of all ages by providing essential nutrients, vitamins and minerals. Through the use of natural and nontoxic ingredients, the nutritional supplements are designed to provide beneficial vitamins and minerals without leading to violations of anti-doping regulations or causing other detrimental effects. Especially preferred formulations include the combination of various essential amino acids and vitamin B combinations that are stable and can be delivered orally as a spray.

This application is a continuation-in-part of application Ser. No. 13/451,329, filed Apr. 19, 2012 in the name of Leroy P. Kemp, Woo Chun Paik and Mia Scheid. application Ser. No. 13/451,329 is hereby incorporated by reference in its entirety.

### BACKGROUND OF THE INVENTION

1. Field of the Invention

This invention relates generally to natural nutritional supplements and in particular to dietary nutritional supplements that are specially formulated for use by athletes and preferably delivered as a controlled spray.

2. Description of the Related Art

Nutritional supplements and multivitamins are well known in the art. However, currently available nutritional supplements fail to satisfy the dietary needs of athletes with demanding physical workout regimens that result in the loss of vital nutrients and fluids. In particular, high school, college and professional athletes, especially wrestlers, have a special need for dietary nutritional supplements because they often lose weight in order to remain competitive at their particular weight class. Thus, a wrestler who might compete at the 123 pound level might have a normal weight of 150 pounds and is thus required to lose 27 pounds prior to competition. One common technique for reducing weight used by wrestlers is to dehydrate prior to the weigh-in for a competition and then rehydrate afterwards. This physically demanding regimen often causes a loss of electrolytes, vital nutrients and fluids, and dehydration.

Moreover, currently available nutritional supplements are often developed for mass marketing and consumption. As a result, these nutritional supplements are manufactured to maximize convenience for the consumer and quality is often sacrificed. Mass produced nutritional supplements often include undesirable ingredients such as preservatives, chemicals and heavy metals rather than natural, clean, safe and non-toxic ingredients.

A need therefore exists for clean, safe, natural and non-toxic dietary nutritional supplements that are specially formulated for use by athletes to replenish the lost nutrients and fluids after workouts and provide the strength, endurance, stamina and energy required for high intensity competition. Dietary nutritional supplements, such as those described herein, are believed to be particularly useful.

Further, energy drinks have captured a significant market, but frequently rely almost exclusively on sugar and caffeine to increase energy. Most are delivered by drinking a controlled quantity from a container. A need exists, therefore, for a natural energy supplement that can be delivered in controlled quantities by spray.

### SUMMARY OF THE INVENTION

The present invention relates to a family of dietary nutritional supplements that are specially formulated for use by high school, college and professional athletes, especially wrestlers. The formulations help build endurance and stamina, replenish electrolytes lost during intense sweating and help supply nutrients and sustain energy. While specially designed for athletes with demanding workout routines, the formulations described herein can also provide beneficial nutrients, vitamins and minerals to persons of all ages and activity levels. For example, formulations described herein can be beneficial to children and persons on the go who often fail to obtain necessary nutrients through consumption of regular meals. Likewise, persons desiring to lose weight can benefit from formulations described herein that help curb hunger while still providing essential nutrients.

These formulations are also designed to be clean, safe, natural and non-toxic. The formulations are prepared in a way to preserve the beneficial effects of the ingredients and avoid the introduction of preservatives, chemicals and heavy metals. Through proper preparation and ingredient combinations, the formulations avoid doping violations while still providing athletes with the nutritional supplements needed to support their rigorous training routines. When possible, the nutrients described in the formulations below are preferably delivered as concentrates from once-living sources to provide ideal cellular rejuvenation. Further, the formulations described herein preferably avoid excipients such as fillers, binders, artificial colors or other toxic tagalongs, which have the potential to cause health problems if consumed over time.

In one embodiment, a combination of Green Blend (consisting of one or more of barley grass, wheat grass, avena sativa, chorella, blue green algae, noni and coriander) and Mineral Blend (consisting of one or more of coral mineral and calcium pyruvate) can be used to advantage. This combination can be further combined with one or more of Antioxidant Blend (consisting of one or more of palm juice or other natural sugar, blueberry, pine pollen and vanilla), Fiber Blend (consisting of one or more of arabinogalactan, guar gum, and fructo-oligosaccharides), and/or whey protein for greater advantage. In another embodiment, the ingredient docosahexaenoic acid (DHA), and at least one of the ingredients, cordyceps, reishi, and 5′-monophosphate ribonucleotides, can be combined to advantage.

In a different embodiment, the combination of B-Vitamin Blend (consisting of one or more of thiamin, riboflavin, vitamin B6, folate, vitamin B12, niacin, biotin, pantothenic acid, para aminobenzoic acid, and inositol) can be combined with Cacao Blend (consisting of cacao bean, and preferably one or more of calcium bentonite and palm juice or other natural sugar) to advantage. This and other Vitamin B containing embodiments can be used as a natural energy supplement combining amino acids and Vitamin B and can be delivered in measured amounts from a spray container. In another embodiment, the combination of Mediterranean sea salt, Hawaiian red clay sea salt, and palm juice or other natural sweetener can be used to advantage.

### DETAILED DESCRIPTION OF THE PREFERRED EMBODIMENT

These preferred embodiments are described in sufficient detail to enable those skilled in the art to practice the invention; however, it is understood that other embodiments may be utilized and changes may be made without departing from the scope and spirit of the present invention. The description of preferred embodiments may omit certain information known to those skilled in the art to avoid detail not necessary to enable those skilled in the art to practice the invention. The following detailed description is not to be taken as limiting and the scope of the present invention is to be defined by the claims.

The present invention is described herein by four examples: Formulation 1, Formulation 2, Formulation 3 and Formulation 4.

The following detailed descriptions of the Formulations provide tables of the preferred ingredients and amounts as well as supplemental beneficial ingredients. Those of ordinary skill in the art will recognize the following abbreviations used throughout this detailed description: “g” refers to grams, “mg” refers to milligrams, “mcg” refers to micrograms, “oz.” refers to ounces, and “ml” refers to milliliters.

### Formulation 1

The first preferred dietary nutritional supplement, Formulation 1, preferably contains natural ingredients in powder form. Formulation 1 is preferably added to a beverage (i.e., water, rice milk or low-acidic juice) immediately prior to consumption to ensure freshness and retain the full benefits of the included ingredients. Formulation 1 aids in recovery after high intensity workouts or serves as a nutrient-rich meal-replacement shake. Formulation 1 can curb hunger and reduce body fat and mass while still supplying the body with key essential vitamins and minerals. The preferred ingredients and amounts are provided in Table 1. Table 1 gives relative quantities by weight to illustrate a possible composition for Formulation 1. The typical serving size for Formulation I is one packet weighing approximately 1.75 oz.

TABLE 1

| | Amount Per | |
|---|---|---|
| Ingredient | Serving | |
| Whey Protein | 12.5 | g |
| Antioxidant Blend | | |
| Palm Juice (dehydrated) | 14.0 | g |
| Blueberry (fruit powder) | 6.0 | g |
| Vanilla (powder) | 1.9 | g |
| Pine Pollen | 1.0 | g |
| Mineral Blend | | |
| Coral Mineral (powder) | 5.2 | g |
| Calcium Pyruvate | 1.5 | g |
| Fiber Blend | | |
| Arabinogalactan (extract) | 2.0 | g |
| Guar Gum | 1.4 | g |
| Fructo-oligosaccharides | 0.1 | g |
| Green Blend | | |
| Barley Grass (powder) | 3.03571 | g |
| Wheat Grass (powder) | 0.375 | g |
| Avena Sativa (powder) | 0.375 | g |
| Chorella (whole) | 0.09464 | g |
| Noni (fruit, seed) | 0.04820 | g |
| Blue Green Algae | 0.04648 | g |
| Coriander (leaf powder) | 0.025 | g |

Formulation 1 preferably comprises the combination of (1) whey protein, (2) Green Blend and (3) Mineral Blend. Whey protein is a mixture of globular proteins isolated from whey and preferably included in Formulation 1 as a raw source (unpasteurized) in an amount between 10 g and 25 g per serving. Green Blend preferably includes one or more of the ingredients noni, blue green algae, barley grass, wheat grass, avena sativa, chorella and coriander. Green Blend preferably includes noni (fruit, seed) in an amount between 0.035 g and 0.06 g per serving. Green Blend preferably includes blue green algae in an amount between 0.035 g and 0.06 g per serving. Barley grass is another particularly beneficial ingredient of Green Blend, especially when present in an amount between 2.2 g and 3.8 g per serving. Wheat grass is also particularly useful in Green Blend and is preferably present in an amount between 0.28 g and 0.48 g per serving. Preferably, Green Blend further includes avena sativa in an amount between 0.28 and 0.48 g per serving. Mineral Blend preferably includes coral mineral (powder) in an amount between 3.9 g and 6.5 g per serving. Further, Mineral Blend preferably includes calcium pyruvate in an amount between and 1.125 g and 1.875 g per serving.

The combination of Whey Protein, Green Blend and Mineral Blend is further preferably combined with Antioxidant Blend (preferably consisting of one or more of blueberry, vanilla, pine pollen and palm juice or other natural sugar) and/or Fiber Blend (preferably consisting of one or more of arabinogalactan, guar gum, and fructo-oligosaccharides). The combination of Formulation 1 can also be combined with vitamin D3 crystals to provide further beneficial vitamins not present in typical diets.

In its preferred embodiment, Formulation 1 is dispensed in a powder form, which is preferably mixed with 16 oz. of liquid to produce a nutrient-rich beverage. Particularly, Formulation 1 provides a daily way to obtain a rich supply of nutrients, including a wide array of vitamins and minerals not found in commonly-consumed foods. This Formulation provides necessary carbohydrates, fiber, protein, calcium, iron, vitamin A, vitamin C and other valuable vitamins and minerals.

Formulation 1 also acts as a meal replacement that can be taken in the morning as a first meal for athletes (or dieters) desiring to lose weight while still providing the aforementioned nutrients and curbing hunger. Formulation 1 can also serve as a meal replacement at any time of day for those seeking to lose weight for athletic competition or otherwise. Formulation 1 can be combined with a liquid such as water, rice milk or low-acidic juice to create a nutrient-rich protein drink capable of replenishing muscles when taken immediately after workouts. This protein drink can also be taken before exercise to supply the muscles with protein and carbohydrates necessary for upcoming workouts. Formulation 1 is preferably combined with the desired liquid immediately prior to consumption to ensure that the ingredients retain their full beneficial effects and freshness.

### Formulation 2

The second preferred dietary nutritional supplement, Formulation 2, contains natural ingredients preferably in capsule form. Formulation 2 is beneficial in building power, strength and endurance and enhancing an athlete's overall conditioning level. Table 2 gives relative quantities by weight to illustrate a possible composition for Formulation 2. The typical serving size for Formulation 2 is approximately 900 mg dispersed between three capsules.

TABLE 2

| | Amount Per |
|---|---|
| Ingredient | Serving |
| DHA Capsule(s) | |
| DHA (docosahexaenoic acid) | 400.00 mg |
| Herbal Capsule | |
| Cordyceps (fermented cordyceps | 200.00 mg |
| extract (mycelia)) | |
| Reishi (raw, ground, fruiting body) | 200.00 mg |
| 5′-Monophosphate Ribonucleotides | 100.00 mg |
| (from saccharomyces cerevisiae) | |

Docosahexaenoic acid (DHA) is an omega-3 fatty acid particularly useful to the present invention. DHA is an essential oil particularly useful to athletes because of its ability to reduce inflammation. DHA is preferably present in a quantity between 200 mg and 800 mg per serving. In a preferred embodiment, DHA is preferably combined with one or more of cordyceps, reishi and 5′-monophosphate ribonucleotides.

Cordyceps and reishi are types of fungi particularly useful in the present invention. Cordyceps acts as a true performance enhancer while reishi provides essential liver support. It will be appreciated that the benefits of cordyceps and reishi will be obtained when present in a quantity between 100 mg and 1000 mg per serving each. 5′-monophosphate is a ribonucleotide particularly useful to the present invention, especially when present in a quantity between 75 mg and 1000 mg per serving. 5′-monophosphate ribonucleotides bring proteins together and supports a healthy immune system. Other ingredients beneficial to Formulation 2 and preferably combined with DHA include: sunflower oil, ascorbyl palmitate, sunflower lecithin, tocopherols, and rosemary extract.

In a preferred embodiment, Formulation 2 is dispensed in capsule form and can enhance performance. The preferred form for the capsule is a vegetable cellulose capsule (preferably consisting of corn starch, glycerin, water, carrageenan, sorbitol, beta-carotene, and caramel color). Specifically, the ingredients in Formulation 2 should be provided in separate capsules. The ingredient of DHA is preferably provided in one or two capsules (two capsules being particularly useful when DHA is combined with other liquid ingredients described above) while the ingredients of cordyceps, reishi and/or 5′-monophosphate ribonucleotides are preferably combined and packaged in another separate capsule for consumption. While all of the ingredients are preferably consumed at the same time, it is beneficial to separate the ingredients prior to consumption to maintain freshness and prevent oxidation of the ingredients as occurs when mixed together. Separation of the ingredients until consumption ensures that the full beneficial effects of the natural ingredients will be preserved.

When properly prepared, Formulation 2 provides a way to build endurance and stamina while strengthening the immune system through daily consumption of adaptogenic herbs (reishi and cordyceps) along with key essential fatty acids and nucleotides. This Formulation helps increase athletic output and conditioning levels. Formulation 2 further provides a way for athletes to obtain important essential fatty acid (EFA) oils through daily consumption, preferably when taken in the morning. Formulation 2 also provides a way, through daily consumption, to optimize blood supply to vital organs, improve the body's oxygen uptake, reduce blood pressure, aid metabolism of fat, lower blood cholesterol, and increase the functioning of the cellular system as a whole.

### Formulation 3

The third preferred dietary nutritional supplement, Formulation 3, contains natural ingredients preferably in the form of a dual packet. The dual packet preferably comprises a first packet of liquid ingredients (B-Vitamin Blend) and a second packet of dry ingredients (Cacao Blend). When the ingredients from the first and second packets are consumed together, Formulation 3 delivers maximum sustainable energy without caffeine or other harmful stimulants that can be taken straight or mixed with water or other similar liquid. The preferred ingredients and amounts are provided in Table 3. Table 3 gives relative quantities to illustrate a possible composition for Formulation 3. The typical serving size for Formulation 3 is one packet of liquid ingredients (B-Vitamin Blend) with a volume of approximately 10 ml and one packet of dry ingredients (Cacao Blend) with a weight of approximately 0.36 oz.

| | Amount Per | |
|---|---|---|
| Ingredient | Serving | |
| B-Vitamin Blend | | |
| Thiamin | 5.1 | mg |
| Riboflavin | 0.14 | mg |
| Vitamin B6 | 0.07 | mg |
| Folate | 800 | mcg |
| Vitamin B12 | 22 | mcg |
| Niacin | 25 | mg |
| Biotin | 2200 | mcg |
| Pantothenic Acid | 4 | mg |
| Para Aminobenzoic Acid | 80 | mg |
| Inositol | 700 | mg |
| Cacao Blend | | |
| Dehydrated Palm Juice | 8.5 | g |
| Cacao Bean Powder | 1.2 | g |
| Calcium Bentonite Powder | 0.5 | g |

In a preferred embodiment, B-Vitamin Blend (preferably consisting of two or more of thiamin, riboflavin, vitamin B6, folate, vitamin B 12, niacin, biotin, pantothenic acid, para aminobenzoic acid, and inositol) is combined with Cacao Blend (consisting of at least cacao bean, and preferably consisting of calcium bentonite and palm juice or other natural sweetener).

The following liquid ingredients are particularly beneficial to B-Vitamin Blend. Thiamin, or vitamin B 1, is a water-soluble vitamin of the B complex particularly useful in the present invention and preferably present in a quantity between 3.825 mg to 6.375 mg per serving. Riboflavin, or vitamin B2, is an easily absorbable vitamin of the B complex preferably present in a quantity of 0.1 mg to 0.175 mg per serving. Vitamin B6 is a water-soluble vitamin of the B complex preferably present in a quantity of 0.05 mg to 0.0875 mg per serving. Folate, also known as vitamin B9, is a water-soluble vitamin of the B complex preferably present in a quantity of 200 mcg to 800 mcg per serving. Vitamin B12 is a water-soluble vitamin of the B complex particularly useful in the present embodiment when present in a quantity between 16.5 mcg and 27.5 mcg per serving. Niacin, also known as vitamin B3, is a water soluble vitamin of the B complex preferably present in a quantity between 20 mg and 50 mg per serving. Biotin, otherwise known as vitamin H, is a water-soluble vitamin of the B complex especially useful in the present invention and preferably present in an amount between 1650 mcg and 2750 mcg. Pantothenic acid, or vitamin B5, is a water-soluble vitamin of the B complex particularly useful in the present embodiment and preferably present at a range between 3 mg and 5 mg per serving. Para aminobenzoic acid (PABA) is an organic compound partially soluble in water and preferably present in an amount between 60 mg and 100 mg per serving. Inositol is a well-absorbed naturally-occurring chemical compound preferably present at a range between 525 mg and 875 mg per serving.

The following dry ingredients are particularly beneficial to Cacao Blend. Cacao bean powder is preferably present at a quantity between 0.9 and 1.5 g per serving. Dehydrated palm 10 juice or other natural sugar is preferably present at a quantity between 6.375 g and 10.375 g per serving. Calcium bentonite powder is preferably present in a quantity between 0.375 and 0.625 g per serving.

Other ingredients beneficial to Formulation 3 and capable of combination with the liquid ingredients of B-Vitamin Blend include: water (purified), alcohol (organic), blackstrap molasses (organic), inactive probiotic culture, noni (fruit), nopal (pad), red clover (blossoms), red raspberry (leaf), dong quai (root), chaste tree (fruit), turmeric (root), fo ti (root), hyssop (leaf), white oak (bark), slippery elm (bark), stinging nettle (leaf), maitake extract (fruiting body), asparagus (root), yucca (root), horsetail (herb), garcinia (extract, fruit), arabinogalactan, fructo-oligosaccharides, and dehydrated coconut palm nectar.

In its preferred embodiment, Formulation 3 is provided in a dual packet, with a first packet containing B-Vitamin Blend (the liquid ingredients) and a second packet containing Cacao Blend (the dry ingredients). The separate packets are preferably consumed simultaneously. It will be appreciated that the separate packets are best combined immediately before consumption to ensure freshness and maintain the beneficial effects of the ingredients described herein. The separate ingredients of formulation 3 can be combined with a small amount of liquid (for example, 2 oz. of water) to provide a quick boost of energy. In this embodiment, Formulation 3 provides a way to get a completely natural and sustained energy and alertness boost prior to wrestling or competing in other athletic events. Formulation 3 can provide a way to naturally enhance alertness when tired or fatigued and can be consumed anytime an alertness boost is desired. Alternatively, the ingredients of Formulation 3 may be combined with a larger quantity of liquid (for example, one liter of water) and consumed steadily throughout the day to provide a completely natural way to stay alert all day.

### Formulation 4

The fourth preferred dietary nutritional supplement, Formulation 4, contains natural ingredients in dry form but preferably combined with a liquid to create a completely natural electrolyte and glucose replacement drink. The unique combination of ingredients provided in Formulation 4 can contain as many as 75 valuable trace minerals including magnesium, potassium, calcium, and sodium chloride. Importantly, these minerals, when undamaged by heat or processing, retain their high energy and natural molecular structure, qualities that are ideal for helping to maintain the extracellular and intracellular fluid balance in the body. Formulation 4 also contains the correct ratio of glucose-to-electrolyte balance for maximum rehydration and glucose replacement for high-energy athletes. The preferred ingredients and amounts are provided in Table 4. Table 4 gives relative quantities by weight to illustrate a possible composition for Formulation 4. The typical serving size for Formulation 4 after it is mixed is an approximately 9.0 g package.

TABLE 4

| Ingredient | Amount Per Serving |
|---|---|
| Mediterranean Sea Salt | 3.2 g |
| Hawaiian Red Clay Sea Salt | 1.6 g |
| Dehydrated Palm Juice | 4.2 g |

Mediterranean sea salt, a natural mineral particularly useful to the present embodiment is preferably present in an amount between 2.0 g and 6.0 g per serving. Hawaiian red clay sea salt, another natural mineral particularly useful to the present invention, is preferably present in a quantity between 1.0 g and 3.0 g per serving. Dehydrated palm juice, or another natural sweetener, is particularly useful in the present embodiment when present at an amount between 2.5 g and 5.0 g per serving.

In its preferred embodiment, Formulation 4 is dispensed in a powder form in a packet and mixed with water, preferably immediately before consumption to preserve freshness and maximize the beneficial effects of the ingredients described herein. The dry ingredients can be mixed with an amount of liquid as desired for taste, preferably 16 oz. or more of water. Formulation 4 can be consumed quickly to immediately replenish electrolytes and glucose lost during intense sweating or sipped throughout the day to provide important minerals all day.

It will be apparent to one of ordinary skill in the art that the nutritional supplement Formulations can be made using well-known conventional batch manufacturing techniques where dry ingredients (and liquid ingredients) are mixed, stirred and packaged without regard to a specific sequence while maintaining the beneficial effects described herein. However, it is important to keep the liquid and dry ingredients separate until immediately prior to consumption to preserve freshness and maximize the beneficial effects of the natural ingredients.

The ingredients described herein should never be processed or heated above a temperature of 120 degrees Fahrenheit or stored at temperatures above 120 degrees Fahrenheit after packaging. More preferably, the ingredients should not be heated or stored at a temperature above 110 degrees Fahrenheit because this may alter the natural and beneficial properties of the ingredients. It will also be appreciated that the ingredients described herein are preferably natural and organic, and that preservatives, chemicals, heavy metals and other toxins should not be included with or allowed to enter the Formulations. Moreover, while it is important to use safe and natural ingredients, it will further be recognized that the materials used for preparing and packaging the ingredients should be non-toxic and safe to avoid contamination of the ingredients during or after packaging.

Together the family of supplements described above can support an athlete's ability to rehydrate, recover, build strength and support endurance. For purposes of illustration only, the following suggested amounts of the various Formulations may be recommended for use by a wrestler or other athlete before competition, during competition, after competition, and for general daily consumption:

Before Competition (1-2 hours prior):
1. Mix Formulation 1 with 16 oz. of liquid and consume 2-4 oz.
2. Consume one serving of Formulation 2.
3. Mix Formulation 3 with 2-4 oz. of water and consume entire mixture.

### During Competition:

1. Mix Formulation 4 with 16 oz. of water and consume 4-8 oz.
2. Mix Formulation 1 with 16 oz. of liquid and consume 4-6 oz. (or more based on hunger).
3. Mix Formulation 3 with 4-6 oz. of water and consume steadily.

### After Competition:

1. Mix Formulation 4 with 16 oz. of water and consume entire mixture.
2. Mix Formulation 1 with 16 oz. of liquid and consume entire mixture.
3. Consume one serving of Formulation 2.

### General Daily Consumption:

1. Mix Formulation 1 with 16 oz. of liquid and consume as desired (preferably as a meal replacement).
2. Consume one serving of Formulation 2 (preferably in the morning).
3. Mix Formulation 3 with 8 oz. liquid and consume as desired for energy.
4. Mix Formulation 4 with 16 oz. of water and consume throughout the day.

### Formulation 5

Amino acids serve as both building blocks for muscle protein, as well as a source of energy for skeletal muscle. Dietary amino acid supplementation is known to have beneficial effects on muscle function, fatigue, and recovery in exercising athletes. Amino acids have also shown to benefit muscular fatigue due to exercise, resulting in favorable changes including an increased oxygen-carrying capacity of blood. By virtue of its integral association with proteins, amino acid supplementation represents a preferred component in supporting a healthy blood sugar balance, aside from its significance in the maintenance of muscular protein and muscle tone.

In athletes, endurance training has shown to result in an increase in amino acid oxidation and urea excretion along with a decrease in protein synthesis in the liver, heart and stromal fraction of the muscle, implicating a probable benefit to amino acid supplementation. In the gastrointestinal tract protein is broken down into amino acids via the action of pepsins, which cleave peptide linkages. The ingestion of free form amino acids results in a rapid, multiple fold increase in the plasma amino acid level, which has been correlated to an increased production of red blood cells. Free forms of amino acids, specifically the essential amino acids, are absorbed quicker than that of the nonessential amino acid. Along with exercise the intake of oral amino acids facilitates a decrease in muscle protein loss.

B vitamins are often called the energy vitamins, but they are more directly the keys that unlock it. Fatigue, irritability, poor concentration, anxiety and depression—all can be signs of a B vitamin deficiency. That's because compounds in the B complex are needed for everything from the healthy maintenance of brain cells to the metabolism of carbohydrates, the brain's source of fuel. B vitamins are also necessary for production of neurotransmitters, which regulate mood and conduct messages through the brain. One of the primary functions of B-complex vitamins is to help metabolize carbohydrates, fats and proteins and help your body unlock and utilize the stored energy in food. Vitamin B-1, or thiamine helps break down carbohydrates and fats. Vitamin B-2, or riboflavin helps transport energy within cells. Vitamin B-5, or pantothenic acid, contributes to the structure of several enzymes that metabolize fats, including coenzyme A, which plays an important role in the synthesis and breakdown of fatty acids. Vitamin B-12, or Cobalamin works with other B vitamins to produce oxygen carrying red blood cells.

The benefits of using Formula 5 type products include the following:
They may support glucose regulation and the Krebs Cycle, without raising insulin levels
   Raising insulin levels causes a crash in energy.
   The Krebs Cycle may be a part of how living cells convert food into energy. It is a series of chemical reactions that generate a molecule called ATP (adenosine tri-phosphate), which almost all living things use to power themselves.
Since amino acids play a functional role in blood sugar stabilization Formula 5, containing glycogenic ammo acids, may support symptoms of low blood sugar.
   Of the twenty amino acids the glycogenic amino acids play a significant role in this function.
   A glycogenic ammo acid is defined as one that can be converted into glucose via glconeogenesis.
Amino acids may work to build proteins in the body, necessary to create new and healthy cells, and are vital for proper cell function.
Formula 5 may also support nutrient delivery to muscles as well as nourish muscle growth and recovery which is important and necessary for optimal performance for athletes.

A glycogenic ammo acid is generally defined as one that can be converted into glucose via glconeogenesis. The glycogenic amino acids in humans are present in Formulation 5 and generally include: Glycine, L-Serine, L-Threonine, L-Valine, L-Histidine, L-Arginine, cysteine, L-Proline, L-Alanine, glutamate, glutamine, aspartae, asparagine and methionine.

The administration of amino acids in both a balanced combination as well in an easily absorbed form, such as an aqueous solution or easily dissolvable capsules, offers distinct advantages over formulations contained in compacted tablets. With regard to therapeutically balancing blood sugar fluctuations, and stabilizing blood sugar, the use of less absorbable forms is typically less than desirable.

Persons with digestive disorders, including hypochlorhydria, celiac disease, irritable bowel disease, and colitis may have an added need for amino acids, since absorption is limited or diminished. For these individuals and for athletes wanting to offset amino acid oxidation, an oral, easily assimilated form of amino acid supplementation may be advantageous.

The following formulation has been found to be particularly useful, since it has stability over long periods, that is, the B Vitamins do not significantly degrade over time.
B1 (Thiamine)
B2 (Riboflavin)
B3 (Niacin)
B6 (Pyridoxine)
B12 (Cobalamin)
B7 (D-Biotin)

Further, the following nonessential amino acids may help create optimal health for athletes. Listed below are the non-essential, glycogenic amino acids used in the preferred embodiment:
Alanine: During exercise, muscle tissue breaks down and toxins are released. Alanine works to remove these toxins and eliminate them from the body.
Asparagine: Helps the nervous system maintain its equilibrium. It also acts as a detoxifier in the system and regulates metabolism.
Aspartic Acid: Due to its effect on cellular energy, it is used to combat fatigue and depression.
Glycine: Supplies beneficial glucose the body needs for energy especially during exercise. Essential for proper cell growth and function, and crucial to digestive health. Glycine makes up a large portion of collagen that helps skin retain its elasticity and healing properties.
Histidine: Important in the production of red and white blood cells, and repair body tissue.
Proline: Necessary to create new and healthy cells. A proponent of collagen and cartilage, Proline helps keep muscles and joints pliable.
Serine: Essential to brain function, particularly the chemicals that determine mood and mental stability. Found in all cell membranes and aids in muscle formation and immune health.
Threonine: A protein balancer in the body, threonine helps to form tooth enamel, stabilize blood sugar levels and assists in healthy liver function. It also acts as a stress reducer and skin rebuilder.

It has been determined that the best way to deliver the measured amounts of this natural energy formula is as a spray. Specifically, each two-ounce bottle can contain 30 servings of the preferred formulation which combines essential amino acids and Vitamin B. Each spray contains 0.2 ml of product; 10 sprays are preferred per day are considered 1 serving and have been determined useful in maintaining improved energy levels. A two-ounce bottle contains 30 servings or 60 ml.

Modifications to the above-described Formulations including preferred Formulation 5 and combinations thereof are contemplated—including elimination of one or more components or substitution of equivalent components—without departing from the spirit and scope of the invention claimed. It will be appreciated that the ranges of preferred quantities are provided herein to illustrate the amounts at which the ingredients are most effective. It will be appreciated that in many instances, a larger quantity may be provided without adverse effect, though often, a greater quantity will provide no further beneficial effect either. It will also be appreciated that the ingredients described herein may be provided in a smaller quantity, though this will likely reduce the desired beneficial effect.

It should be apparent from the foregoing that the present invention provides significant benefits over the prior art. While the present invention is demonstrated through particular embodiments, the invention is not so limited but is amenable to variations and modifications thereof.

We claim:

1. A nutritional supplement comprising the combination of B-Vitamin Blend including at least B1 (Thiamine), B2 (Riboflavin), B3 (Niacin), B6 (Pyridoxine), B12 (Cobalamin) and B7 (D-Biotin) and the combination of at least 8 of the following amino acids: Glycine, L-Serine, L-Threonine, L-Valine, L-Histidine, L-Arginine, cysteine, L-Proline, L-Alanine, glutamate, glutamine, aspartae, asparagine and methionine.

2. The nutritional supplement of claim 1 delivered in the form of a spray.

3. The nutritional supplement of claim 2 in which the spray container has sufficient supplement for ten 0.2 ml sprays per day for 30 days.
